(19) United States
(12) Patent Application Publication
(10) Pub. No.: US 2009/0132691 A1
(43) Pub. Date: May 21, 2009

(54) METHOD AND SYSTEM TO MANAGE COMMUNICATIONS

(75) Inventors: Benoit Daurensan, Antony (FR); Bernard Thery, La Celle St Cloud (FR); Francois Vincent, Clamart (FR)

Correspondence Address: PERMAN & GREEN, 425 POST ROAD, FAIRFIELD, CT, 06824, US

(73) Assignee: SOCIETE FRANCAISE DE RADIOTELEPHONE, Paris (FR)

(21) Appl. No.: 12/263,528

(22) Filed: Nov. 3, 2008

(30) Foreign Application Priority Data
Nov. 15, 2007 (FR) 0708018

(51) Int. Cl. G06F 15/173

(52) U.S. Cl. 709/223

(57) ABSTRACT

A method to manage communications between a communication network using radiofrequency waves and a network such as the Internet, linked by a gateway, with control members producing; parameters related to established communications, including a user identifier and a communication identifier, or parameters related to failed connections, including a connection identifier and a user identifier, Internet access by the general public being notably allowed from the radiofrequency network in particular by a step (Etp01) collecting produced parameters, a step (Etp03) processing collected parameters, to adjust at least one saturation indicator, a test step (Etp04) of the indicator, resulting from a transmission capacity command on at least one gateway port dedicated to access offers of general public type.

### BACKGROUND

1. Field

The area concerned by the disclosed embodiments is telecommunications. More particularly, it concerns a method and system to provide access to a high speed network, such as the Internet network for example, from a network having a slower bit rate capacity such as a telecommunications network using radiofrequency waves.

2. Brief Description of Related Developments

A telecommunications network using radiofrequency waves allows access to the Internet via gateways to which mobile terminals connect. The radiofrequency wave telecommunications network is based in particular on equipment resources tolerating data rates that are much lower than those on fixed networks using optical or electric lines such as an Asymmetric Digital Subscriber Line (ADSL) used for the Internet network. Connections to the Internet from a radiofrequency wave telecommunications network are therefore limited in number, with respect to rate or duration, so as not saturate the radiofrequency wave telecommunications network. Such accesses are not therefore adapted for offers to the general public.

There is therefore a need for Internet access from a radiofrequency wave telecommunications network, such access being potentially unlimited so that it can be adapted to offers available to the general public.

### SUMMARY

The aspect of the disclosed embodiments is to eliminate one or more prior art drawbacks, by proposing a method to manage communications to allow access by the general public to the Internet network using a radiofrequency wave telecommunications network.

This purpose is achieved by means of a method to manage communications of mobile terminals in a first communications network using radiofrequency waves managed by an operator, and a second network connected together by a gateway comprising a plurality of communication ports between the first and second networks, the first network being equipped with control members producing:

parameters related to communications set up with mobile terminals, each comprising at least one identifier of the communicating mobile terminal user, and an identifier of the type of communication, or

parameters related to failed connections, each comprising at least one identifier of the type of connection which failed and an identifier of the type of user of the mobile terminal concerned, or

parameters related to occupancy of the resources of the various elements of the first network, in particular of each of the gateway ports between the first and second network,

characterized in that it comprises at least:

a step to collect the parameters produced by the control members,

a step to process the collected parameters to adjust at least one saturation indicator,

a step to test said indicator, resulting from a transmission capacity command on at least one port dedicated to access offers of general public type, from among said gateway ports.

According to another aspect, the test step indicating saturation of the first network, is followed by a step to determine the type of saturation comprising analysis of the collected parameters or adjusted indicators, and comprising an evaluation of communications of the type access to the second network by users of terminals benefiting from general public offers.

According to another aspect, the step to determine the type of saturation comprises access to a database containing at least one of type of subscribed offer associated with each user identifier, so as to match each communication and each failed connection with the type of offer subscribed by the user.

According to another aspect, during the step to determine the type of saturation, the communications or respectively the failed connections of the type access to the second network by users of terminals benefiting from general public offers, are determined by their identifier of communication type, or failed connection type respectively, which comprises the address of the port dedicated to access offers of general public type.

According to another aspect, the step to determine the type of saturation resulting from saturation by communications of the type access to the second network by users benefiting from a general public offer, to the detriment of other types of connections, is followed by a step commanding reduction in transmission capacity towards the second network at the port dedicated to access offers of general public type, and

the step to determine the type of saturation not resulting from saturation by communications of the type access to the second network by users benefiting from a general public offer, is followed by a step to notify insufficient resources in the first network to a device which evaluates material resources.

According to another aspect, the test step indicating non-saturation of the first network is followed by a step to command an increase in the capacity of the port, dedicated to access offers of general public type, to transmit towards the second network.

According to another aspect, the method to manage communications comprises a step to activate a priority management function on the port dedicated to access offers of general public type, giving priority to communications of web browsing type over communications of downloading type.

A further aspect of the disclosed embodiments is to propose a communications system allowing access by the general public to the Internet using a radiofrequency wave telecommunications network.

This objective is achieved by means of a communication system comprising mobile terminals in a first communication network using radiofrequency waves managed by an operator, the first network communicating with a second network via a gateway equipped with a plurality of communication ports between the first and second networks, the first network being equipped with control members producing:

parameters related to communications set up with mobile terminals, each comprising at least one identifier of the user of the mobile terminal in communication, and an identifier of the type of communication, or

parameters related to failed connections, each comprising at least one identifier of the type of failed connection, and an identifier of the user of the mobile terminal concerned, or

parameters related to occupancy of the resources of the different element in the first network, in particularly of each of the gateway ports between the first and second network,

characterized in that it comprises at least one command line for a port of the gateway piloted by device managing elements of the network, the commanded port being dedicated to access offers of general public type,

the command device comprising:

a module to collect parameters,

a module to process the collected parameters, adjusting at least one saturation indicator,

a command module, adjusting the transfer capacity of the port dedicated to access offers of general public type, in relation to the saturation indicator, so as not to encumber the first network or so as to make use of the available bandwidth of the first network.

According to another aspect, the second network is the Internet network, those general public users setting up Internet communications being identifiable in the first network via special marking of the headers encapsulating information transferred by users.

According to another aspect, the gateway e.g. of GGSN type (Gateway GPRS Support Node), or consisting of an independent server positioned between the GGSN of the first network and the second network, activates a priority function on its port dedicated to access offers of general public type, giving priority to communications of web browsing type over communications of download type.

According to another aspect, the control members are integrated in communication nodes of the first network, or are in the form of control probes integrated in the first network.

The invention, its characteristics and its advantages will become better apparent on reading the description disclosed with reference to the figures referenced below given as non-limiting examples:

### BRIEF DESCRIPTION OF THE DRAWINGS

FIG. 1 shows an example of the communications management method according to the disclosed embodiments;

FIG. 2 illustrates an exemplary device to manage communications according to the disclosed embodiments;

FIG. 3 shows an example of a system with two communication networks according to the disclosed embodiments.

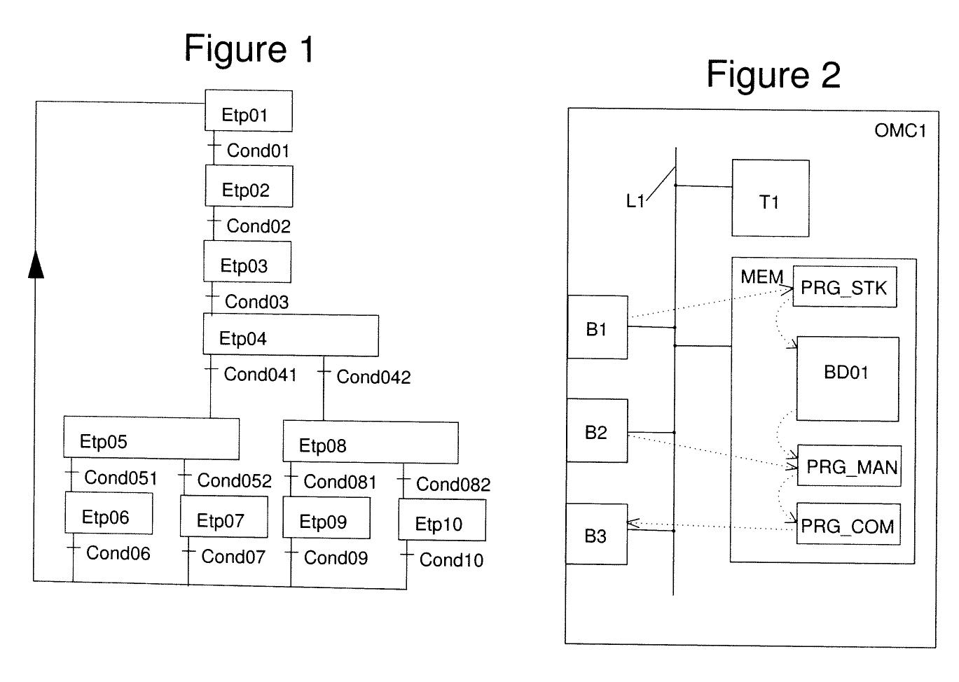

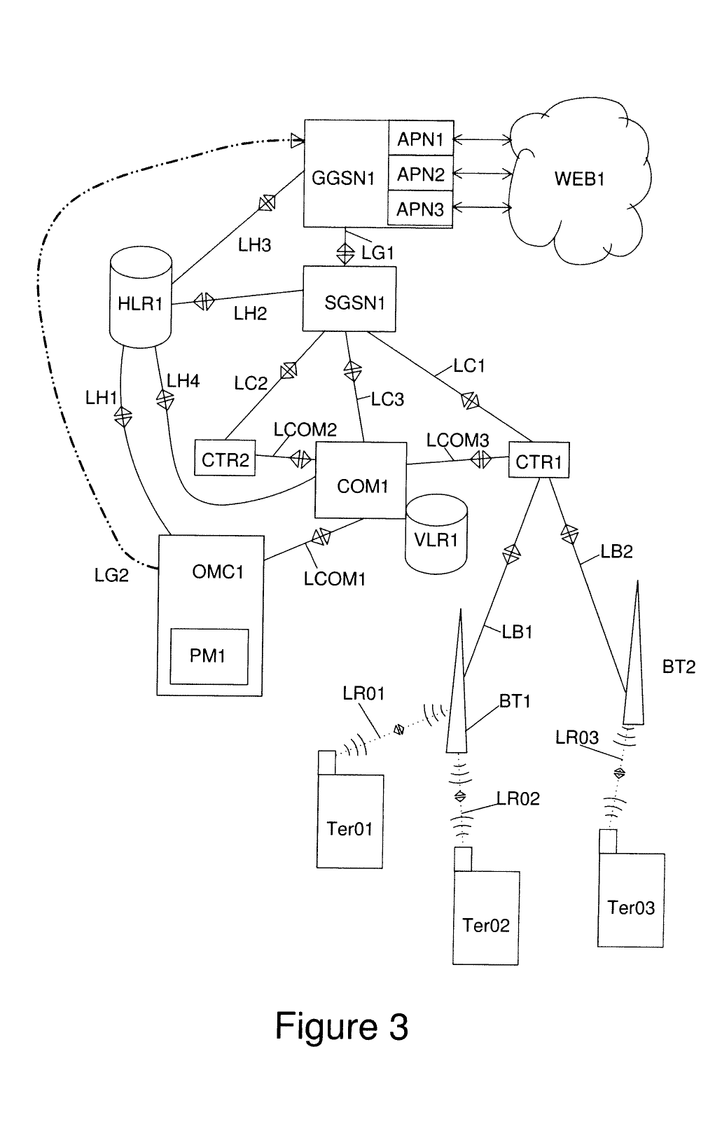

### DETAILED DESCRIPTION OF THE DRAWINGS

The disclosed embodiments will now be described with reference to the above-mentioned figures. A radiofrequency wave communication network, for example a cell phone network, comprises for example a mobile terminal Ter01, Ter02, Ter03, which sets up a communication via a gateway GGSN1 with a high speed network (WEB1), for example the Internet network. The gateway GGSN1 is equipped with several ports APN1, APN2, APN3 or access points also called <<Access Point Names>>. The radiofrequency wave communication network comprises components of GSM type for example (Global System for Mobile Communications), or UMTS (Universal Mobile Telecommunications System), GPRS (General Packet Radio Service), or further HSDPA (High Speed Downlink packet Access).

The mobile terminal Ter01, Ter02, Ter03 is connected to the radiofrequency wave communication network for example, by setting up a radio communication link LR01, LR02, LR03 with a transmission station BT1, BT2. The transmission stations BT1, BT2 are for example of BTS type (Base Transceiver Station) for the GSM/GPRS network, or stations of Node B type for the UMTS/HSDPA network.

These transmission stations BT1, BT2 are managed by controllers for example CTR1, CTR2 which generally each control several transmission stations BT1, BT2. The controller CTR1, CTR2 is linked by electrical or optical communication lines LB1, LB2 to the transmission stations BT1, BT2 controlled by this controller. A controller CTR1, CTR2 may for example be of BSC type (Base Station Controller) for the GSM network, or a controller of RNC type (Radio Network Controller) for the UMTS network.

The controllers CTR1, CTR2 are also linked for example via an interface device SGSN1 to an Internet access gateway GGSN1. The gateway is associated for example with a router device to route communications. The interface device is for example of SGSN type (Serving GPRS Support Node), associated with a gateway of GGSN type (Gateway GPRS Support Node). The interface device SGSN1 communicates for example via a link LH2 with a database HLR1 containing communication management data which, for example and for each subscriber, comprises the subscriber's international identity in its IMSI code form (International Mobile Subscriber Identifier), subscriber number and the service offer(s) to which the subscriber has subscribed with the telecommunications operator. The database (HLR1) containing communications management data is of HLR type for example (Home Location Register). The interface device SGSN1 manages the transfer of packets for example between a mobile terminal and the Internet access gateway.

In non-limiting manner, a controller of RNC type is linked via a communication link LC1, LC2 to the interface device SGSN1, or a controller of BSC type, equipped with a communications module using packets such as a PCU module (Packet Control Unit) is linked via a communication link LC1, LC2 to the interface device SGSN1.

In non-limiting manner, a communication between a controller and the interface component of the gateway can be set up via one or more intermediate communication components. A controller CTR1, CTR2 e.g. of BSC type sets up a communication with the gateway, for example using the interface component SGSN1, via a router. The router component is linked firstly to the controller CTR2, CTR1 via a link LCOM2, LCOM3, and secondly another link LC3 links the router COM1 to the interface device SGSN1 with the gateway.

The gateway GGSN1 is linked for example via a communication link LG1 to the interface device SGSN1, and via another communication link LH3 to the database (HLR1) containing communication management data. The gateway e.g. of GGSN type is therefore used as interface between an operator's mobile network and the public Internet network (WEB1) or other high speed networks.

A router COM1 is linked, for example via links LCOM1, LCOM2, to the controllers CTR1, CTR2. The router COM1 is also linked for example via another communication link LH4 to the database (HLR1) containing communication management data, via another communication link LC3 to the interface device SGSN1, and via another communication link LCOM1 to the management device OMC1.

The communication nodes, such as the transmission stations for example BT1, BT2, the controllers CTR1, CTR2 or the routers COM1, linked together by communication lines, allow the transmitting of several types of data according to one or more types of data transmission protocols. The transported data are for example voice data, text messages, multimedia messages, management data or other types of data. An administration network is added for example to the communication network. The administration network may for example comprise administration lines linking communication nodes of the network to the management device. These communication lines of the administration network are arranged for example parallel to the lines between communication nodes, and are dedicated for example to the transmission of data used to manage the network.

The radiofrequency wave communication network is used for example for telephone communications or for the transmission of text messages of SMS type. A mobile terminal user may also set up a communication with a terminal of another network, such as the Internet for example, the transmitted data corresponding to Internet pages for example of HTML type (Hypertext Markup Language), or programme files, or multimedia files of a FTP site (File Transfer Protocol). Different subscriptions may be offered to a user for example to benefit from different access services.

Subscription to an offer is associated with a quality of service offered to the client. Service quality particularly concerns the transfer of data under good conditions. Service quality is related for example to the availability of network nodes or data rates compared with available transfer capacities. Service quality is also related to transit times, or data and data packet loss rates. The failure rate of connections, in a geographical area covered by one or more transmission stations and for a determined period, may for example be representative of service quality for that geographical area during that period.

Estimation of service quality on a network can be used for example to estimate whether the material resources of the network are sufficient. Therefore, firstly the material resources of the network can be optimized, and secondly performance levels for different applications can be guaranteed to users. Accessibility, response time or connection success rate can therefore be offered to a client as per a determined service quality.

Differentiated service quality can for example be offered for Internet access. A first type of Internet access may for example be guaranteed with very high quality for business-type users. Guaranteed access may relate to a maximum connection failure rate of 2% for example. Business users may use their access to access other networks e.g. to access their database or to receive electronic mail.

A second type of Internet access may guarantee average quality service, for uses of general public type. Such access by the general public may, for example, be of <<best effort>> type. So-called <<best effort>> access corresponds for example to the providing of non-used bandwidth in the radiofrequency wave communication network. An individual or general public user may, for example, use the Internet to download multimedia files or computer programmes or pilots, or to surf information pages also called <<web browsing>>.

The communication nodes or measurement probes arranged in the radiofrequency wave communication network may, for example, transmit data on the operating status of the network. Such data is transmitted via the communication nodes for example, or using the administration network. In non-limiting manner, such data is transmitted for example using parameters such as:

the utilization rate of a line or communication node relative to its maximum transfer capacity,

the number of users generating communications at the measured point in the network, the types of users and types of communications,

connection failure rate, types of failed connections and types of associated users.

The above information is collected at different levels in the first network:

a first collection level may, for example, be at each of the radio base stations BT1, BT2, . . . ,

a second collection level may, for example, be at the controllers CTR1, CTR2, . . . of the base stations,

a third level may, for example, be at SGSN level,

a fourth level may, for example, be at GGSN level.

The information transmitted by the control members, such as communication nodes or probes, may be cross-referred either between each member for example, or with information derived from one or more databases VLR1, HLR1. Information processing is performed by the management device OMC1 which may, for example, collect and store data in a file for example or a database BD1 of network parameters. The fields of the network parameter database are for example:

an identifier of the control member producing this parameter,

a name of the measured or calculated parameter,

one or more values corresponding to the status of the parameter.

This first database, or table, is periodically updated. The time interval between two updates is calculated in relation to the operational capacities of the different nodes and lines concerned. Updating several times per hour is required for proper functioning of the device.

As an addition to this first table, the management device OMC1 is provided with a table describing the connection hierarchy of the network nodes relative to each other, and in particular the attachment of the radio base stations with the controllers, and the attachment of the controllers with the SGSNs.

In non-limiting manner, the management device e.g. of OMC type (Operation and Maintenance Center), is associated with a calculator (PM1) which, for example, performs reading of parameters and adjusts the calculated indicators using determined methods. For example, the calculator processes data using collected network parameters to determine indices representing network status or performance.

The management device is used for example to evaluate the percentage number of radio base stations for which quality criteria (connection failure rate, types of failed connections) exceed the fixed threshold. It can also be used to evaluate the connection failure rate of business-type users over the whole network. A multitude of decision criteria can therefore be determined depending on the guaranteed service quality which the operator wishes to offer to certain types of priority users.

The management device can be used, for example, to evaluate the material needs corresponding to authorized data rates on the network for example. In this way, the material architecture of the network can be improved to meet needs i.e. the services offered to users. These needs correspond to guaranteed services. The connection will be set up with a guaranteed data rate or transfer quality, an error threshold being tolerated for example. Errors may correspond, for example, to a failed connection or deteriorated communication with data loss. Therefore a margin, concerning calculations of data rates on communication lines or calculations of data rates at communication nodes, is necessary to guarantee a service quality taking the error threshold into consideration. The sizing of the network is designed for example to provide for maximum occupancy at determined periods, during which these guaranteed services are ensured.

Additionally, for maximum occupancy of network capacity, the so-called <<best effort>> offer allows available bandwidth to be used at any point of the network outside maximum access periods, thereby achieving network cost-effectiveness.

Also, this type of <<best effort>> offer for maximum occupancy can be used for so-called general public offers, with potentially unlimited Internet access. Internet use for the general public effectively requires the offering of a large number of connections which may necessitate high data flows. With the management of these connections, an Internet access offer for the general public can be ensured without saturating the network bandwidth, the consequence of saturation being permanent deterioration of available services.

The collection of network parameters, performed at regular intervals for example, allows determination of whether the bandwidth is saturated or whether part of the bandwidth remains available. If high demand is placed on the network, i.e. its bandwidth is fully utilized, the management device OMC1 or its associated calculator PM1 may send the Internet access gateway GGSN1 an instruction to reduce the data rate of an Internet access port APN1 associated with the <<best effort>> offer. In this way, the flow of data under the <<best effort>> service offer is reduced to lighten the load on the radiofrequency wave communication network. Since the terminals which subscribe to this type of <<best effort>> offer correspond to general public offers for example, these are associated with a determined port of the Internet access gateway. This port is particularly dedicated to Internet access via a so-called <<best effort>> offer or general public offer.

The terminals associated with a service offer of business type are associated for example with another port APN3 of the Internet access gateway GGSN1. Therefore, a reduction in data flow on the Internet access APN1 port for so-called <<best effort>> services does not affect the data rate for business offers. This reduction, which releases part of the bandwidth, even allows better functioning at the Internet access port APN3 for business service offers. Also, the released bandwidth allows better functioning for the other services of the radiofrequency wave communication network, such as voice transmission, transmission of text messages or access to multimedia portals offered by an operator. The operator's service offers are determined for example by data stored in the SIM card of the mobile terminal, or in the HLR or VLR network database.

It is to be noted that thee device thus described allows optimization of the occupancy of the radiofrequency wave communication network, even if this network is not provided with intrinsic devices allowing end-to-end differentiation between service quality per client or per type of service.

Controlling of the port dedicated to general public offers can be transmitted by existing communication lines for example of the administration network, and sent to the GGSN1 gateway. The gateway interface device SGSN1 conveys a determined number of messages, for example in the form of requests or replies to requests, and may for example refuse a determined number of messages derived from mobile terminals which then receive notice of error or failed connection. Also the gateway GGSN1 transmits a determined number of messages between terminals of the Internet network and mobile terminals, and refuses other communications for example by sending the Internet terminals notice of error or failed connection.

In the event that the network's bandwidth is not fully utilized, the management device sends gateway GGSN1 for example an instruction to increase the data rate via the Internet access port APN1 dedicated to <<best effort>> service offers. In non-limiting manner, the increase is calculated in relation to the available bandwidth so as to make full use of the network. Therefore, during periods of low access to the radiofrequency wave communication network, a large bandwidth becomes available for Internet connection offers to the general public. Users having a so-called <<best effort>> Internet access offer will, for example, leave their Internet connection active a whole day to download a large-size programme or computer file. The transfer of the desired file(s) may be made with one or more interruptions, data transfers occurring during periods when the radiofrequency wave communication network is little engaged by communications benefiting from a guaranteed, constant service quality. Therefore users who have subscribed to a guaranteed, constant service quality are not disturbed while users having a so-called <<best effort>> service offer download large-size files.

In this way, Internet communication data rates, through <<best effort>> service offers, can be reduced are increased according to the network's available bandwidth. In addition, saturation by<<best effort>> Internet communications is taken into account by identifying these specific connection requests. Identification of message of <<best effort>> type is made for example in relation to the addressed port (APN1) in the Internet access gateway (GGSN1), or a user is identified for example via its IMSI used to determine the type of subscription by cross-reference with information derived from the database HLR1 containing communication management data. The management device is therefore able to determine that a saturation is not due to <<best effort>> Internet connections since the number or volume of these connections is negligible for example. In this case, the management device determines that network saturation is due to insufficient material resources in the communication network. Therefore the network management device analyses needs for material resources at the same time as it regulates <<best effort>> connections.

In non-limiting manner, the port dedicated to connections with variable capacity transfer, is associated with a priority function which firstly authorizes communications of web browsing type, then authorizes background communications such as downloads from FTP sites (File Transfer Protocol). The priority function is based for example on signature recognition of data transfer application protocols, thereby enabling the gateway to control the prioritization process. In this manner, within the entirety of communications for general public access to the Internet, certain communications have priority over others. Access to Internet pages of HTML type for example, when browsing the Internet, requires rapidity to achieve interactivity. Internet pages are effectively little voluminous compared with audio or video files downloaded from FTP sites. The transfer of a multimedia file can therefore be interrupted to the benefit of online browsing.

The device to manage communications, as illustrated FIG. 2, comprises in non-limiting manner a processing component T1 communicating via a communication line L1 with a memory component MEM and with communication interfaces B1, B2, B3 having input and output ports. In non-limiting manner, the management device OMC1 consists of a multifunction module communicating via its communication ports with other components of the network, or the communication management device OMC1 comprises several units interacting together, the functions of analysis, storage or command being performed for example by separate specific units.

An example of the method, implemented by the device managing communications in the radiofrequency wave communication network, will now be described. The method is based for example on several programmes or modules interacting together and activated in accordance with changes in environmental conditions or by calling on each other. A step (Etp01) to collect parameters is carried out for example by a module (PRG_STK) which collects and stores network parameters. This module comprises a resident memory programme MEM for example. For example, the programme collects data addressed to its communication port B1, this data being stored for example in a buffer memory of the collection and storage module PRG_STK. The collected data is derived for example from nodes of the communication network, or from probes, or from other control members arranged in the network. In non-limiting manner, the network's control members send data periodically, for example every 15 minutes. In non-limiting manner, data is sent by the different members synchronously or asynchronously.

After receipt (Cond01) of a set of data representing network operating parameters, the collection and storage module PRG_STK performs a classification and storage step in a database BD01 comprising determined fields, adjusted in relation to received parameters for example. All received parameters may be arranged in this database BD1. Execution of the collection and storage programme may for example prompt memory write access to the database BD01. In non-limiting manner, the buffer memory is then emptied to receive new data representing other network parameters.

After classification of parameters received and stored (Cond02) in the database, a step (Etp03) is performed to process the data using a data processing and indicator adjustment module PRG_MAN for example. The processing module may for example comprise different adjustable indicators.

In non-limiting manner, the processing module PRG_MAN comprises one or more processing programmes carrying out cross-processing on stored data, for example in the database of collected parameters or in another database such as the database describing the architecture of the radiofrequency communication network. In non-limiting manner, the processing programmes perform comparison operations with respect to thresholds, to determine whether the network is saturated or whether the bandwidth is fully utilized or below capacity. For example, the processing programmes perform calculation of means or statistical calculations on several equivalent parameters.

The performed processing particularly involves the adjustment of indicators representing the operating status of the network.

A first type of processing may, for example, concern calculation of the percentage number of base stations for which failure, on opening of data transactions, exceeds a fixed threshold. This indicator provides a first level of flow control on the port dedicated to <<best effort>> subscribers, when localised saturation of access points is located in space on a few particular points of the network.

A second type of processing may, for example, concern calculation of the global failure percentage for activation of data transmission sessions in the network. This processing allows adjustment of the data rate authorized on the port dedicated to users of <<best effort>> type as soon as the guaranteed level for business-type users is no longer ensured (or just before, depending on operator preferences or commitments vis- [symbol] -vis clients)

A third type of processing may, for example, consist of adjusting or closing the port dedicated to users of <<best effort>> type as soon as capacities in terms of number of subscribers connected to certain network nodes such as the SGSNs, or the number of simultaneous connections on GGSns exceed the capacities of said equipment, with a view to giving priority to other types of subscribers.

It is to be appreciated that the above processing operations are not limiting regarding the capacities of the device, and can be adjusted to meet service quality commitments entered into by the operator with clients other than <<best effort>> clients, in particular business clients.

After adjustment of one or more indicators (Con03), a following indicator test step may be performed by a command module PRG_COM. In relation to tested indicators, a command programme may for example determine whether the network is saturated (Cond042) or whether the network still has some free bandwidth (Cond041). In non-limiting manner, these tests concern all or part of the network whose parameters have been sent to the communication management device OMC1. The saturated status or partially free bandwidth status may, for example, concern the network analyzed as a whole, isolated points in the network associated with particular phenomena possibly not being taken into consideration.

If at (Cond041) part of the bandwidth is not utilized, the command module may perform an analysis step (Etp05) to analyze available resources. This step (Etp05) may for example comprise calculation on one or more indicators to determine whether the non-utilized part of the bandwidth allows (Cond051) an increase in the data rate granted to <<best effort>> users, or whether (Cond052) the margin of the available bandwidth is negligible and merely represents a security margin to guarantee proper functioning.

If (Cond052) the margin is negligible or corresponds to an operating margin, the network being fully well utilized, adjustment of the data rate at the port dedicated to<<best effort>> users at the Internet access gateway GGSN1 remains unchanged, an identical command being sent to the gateway or no command being sent to adjust the data rate of this port. In non-limiting manner, a hop may be made to step (Etp01) to collect data on network parameters. The command module PRG_COM is placed on standby awaiting new indicator tests to be performed, and the collection and storage module PRG_STK places itself on standby to collect data.

The command programme may also (Etp07) send a command to the gateway GGSN1 to maintain its status, this command being sent by a communication port B3 to the gateway. After sending (Cond07) the command to the gateway to maintain its status, a hop may be made to step (Etp01) to receive data on network parameters.

In the case (Cond051) in which the result of step (Etp05) analyzing available resources indicates that part of the non-utilized bandwidth can be used for additional communications, the command module PRG_COM may for example send a command message to the gateway to increase the transfer capacity of port APN1 dedicated to <<best effort>> offers. The command message is sent for example by a communication port B3 of the management device via a communication line (LG2). After sending (Cond06) this command, a hop may be made to data collection step (Etp01).

In the event that, at indicator test step (Etp04), the result indicates saturation of network (Cond042), the command module PRG_COM performs a step (Etp08) for example to determine the type of network saturation. This step (Etp08) may for example comprise evaluation of the volume of communications corresponding to <<best effort>> service offers, taking into account collected parameters or adjusted indicators.

Evaluation of utilization by <<best effort>> service offers can be used for example, in the event of network saturation, to command a reduction in the transfer capacity at port APN1 dedicated to<<best effort>> service offers, when utilization by so-called <<best effort>> users is excessive. Therefore the bandwidth allocated to these <<best effort>> service offers can be adjusted in relation to network availability.

If saturation by <<best effort>> users is detected (Cond081), a step (Etp09) to command reduction of the data rate at the port dedicated to <<best effort>> offers can be carried out by the command module for example. A command message instructing reduction of the data rate on this port is sent for example to gateway GGSN1, via one or more communication lines. After the sending (Cond09) of this message, a hop may be made to parameter collection step (Etp01).

Also, in the event of network saturation, evaluation (Etp08) of utilization by <<best effort>> users can also be used to determine whether the material resources are sufficient to meet the permanent access offer. The data transmitted may, for example, represent a determined number of connection failures for permanent access offers, this number being greater for example than the number of connections authorized for <<best effort>> service offers, i.e. the number of connections provided for <<best effort>> offers is negligible compared with the different connection requests corresponding to permanent access offers. In this case (Cond082), the management device can determine that there is a shortage of material resources to meet all requested connections, without taking into account or after deducting resources allocated to <<best effort>> offers. A following step (Etp10) notifying a shortage of material resources is performed by the command module for example. A message notifying shortage of material resources is sent to a device evaluating material resources such as another management device, or to another communication management module. In non-limiting manner, detection of a shortage of material resources leads to the sending of a command message to gateway GGSN1 to cut off port APN1 dedicated to <<best effort>> service offers. After sending (Cond10) of the notification message, and optionally after the cut-off command of port APN1 dedicated to <<best effort>> service offers, a return may be made to step (Etp01) to collect network parameters.

Step (Etp08) to evaluate utilization of the network comprises evaluation of the bandwidth used by communications related to <<best effort>> offers. In non-limiting manner, these communications are identified by the address of the gateway port dedicated to<<best effort>> offers. A message sent to this dedicated port is then identified, this address being integrated for example in the parameter representing the resources occupied by this message.

In non-limiting manner, the parameters may also comprise data representing service access characteristics, such as the maximum allowed data rate or a priority class associated with each user. These parameters may, for example, be stored in the management device in a field of the database BD1 relating to data representing communication data rate or resources occupied by this communication. In this way, the module PRG_MAN is able to determine the user's type of subscription, for example to access the Internet.

In non-limiting manner, step (Etp06, Etp09, Etp10) instructing the Internet access gateway to adjust the data rate at the port dedicated to<<best effort>> service offers, is followed by a step to activate a priority function according to the type of communication. The priority function dependent on communication type is used in particular to organize communications according to priority criteria, amongst all communications related to <<best effort>> service offers. Several degrees of priority can be given. Therefore, once part of the bandwidth has been allocated to <<best effort>> offers, a second communication management operation is performed inside this flow of data. The priority function gives priority for example to communications corresponding to web browsing, over so-called <<background>> operations corresponding to downloads for example.

According to one non-limiting embodiment, the gateway GGSN1 comprises several ports controlled according to different priorities. A first port APN2 corresponds for example to <<best effort>> offers for web browsing. A second port is reserved for example for background communications corresponding to downloads for example. A third port may, for example, correspond to highest priority Internet access. The first port may, for example, have priority over the second port, to meet operating logic.

The priorities between several Internet access ports can therefore be managed in relation to user subscriptions, in accordance with the database HLR1 containing communication management data. Therefore different service offers can be made to users.

In non-limiting manner, the communications associated with corresponding offers, by cross-referencing with the database HLR1 containing communication management data, are used to detect any frauds or possible communication errors. In addition, the communication management device OMC1 can be associated with a communications archiving space, which can be used to find a history of communications e.g. for statistical studies.

It will be obvious for persons skilled in the art that the present invention allows embodiments in numerous other specific forms, without departing from the scope of application of the invention as claimed. Therefore the present embodiments are to be construed as illustrations which may be modified within the area defined by the scope of the appended claims, and the invention is not be considered as being limited by the details set forth above.

1. A method to manage communications of mobile terminals in a first radiofrequency wave communication network managed by an operator, and a second network (WEB1), linked together by a gateway (GGSN1) comprising a plurality of communication ports (APN1, APN2, APN3) between the first and second networks, the first network being equipped with control members producing:
parameters related to communications set up with mobile terminals, each comprising at least one identifier of the communicating mobile terminal user, and an identifier of the type of communication, or
parameters related to failed connections, each comprising at least one identifier of the type of failed connection, and an identifier of the type of user of the mobile terminal concerned, or
parameters related to occupancy of the resources of the different elements of the first network, and in particular of each of the ports of the gateway between the first and second network,
wherein it comprises at least:
a step (Etp01) to collect parameters produced by the control members,
a step (Etp03) to process collected parameters so as to adjust at least one saturation indicator,
a step (Etp04) to test said indicator, resulting from a transmission capacity command of at least one port dedicated to access offers of general public type, from among said gateway ports.

2. A communications management method according to claim 1, wherein test step (Etp04) indicating saturation of the first network, is followed by a step (Etp08) to determine the type of saturation comprising analysis of the collected parameters or adjusted indicators, and comprising an evaluation of communications of the type access to the second network by users of terminals subscribing to general public offers.

3. A communications management method according to claim 2, wherein step (Etp08) to determine the type of saturation comprises access to a database containing at least one type of subscribed offer associated with each user identifier, so as to match each communication and each failed connection with the type of offer subscribed by the user.

4. A communications management method according to claim 2, wherein during step (Etp08) to determine the type of saturation, the communications, or respectively the failed connections, of the type access to the second network by users of terminals benefiting from general public offers, are determined by their identifier of communication type, or of failed connection respectively, which contains the address of the port dedicated to access offers of general public type.

5. A communications management method according to claim 2, wherein step (Etp08) to determine the type of saturation resulting from saturation by communications of the type access to the second network by users benefiting from a general public offer, to the detriment of other types of connections, is followed by a step (Etp09) instructing reduction of the transmission capacity, towards the second network, of the port dedicated to access offers of general public type, and
step (Etp08) to determine the type of saturation not resulting from saturation by communications of the type access to the second network by users benefiting from a general public offer, is followed by a step (Etp10) to notify insufficient material resources in the first network, to a device evaluating material resources.

6. A communications management method according to claim 1, wherein test step (Etp04) indicating non-saturation of the first network, is followed by a command step (Etp06) instructing an increase in the transmission capacity towards the second network of the port dedicated to access offers of general public type.

7. A communications management method according to claim 1, wherein it comprises a step to activate a priority management function on the port dedicated to access offers of general public type, giving priority to communications of web browsing type over communications of download type.

8. A communication system comprising mobile terminals in a first communication network using radiofrequency waves managed by an operator, the first network communicating with a second network (WEB1) via a gateway (GGSN1) equipped with a plurality of communication ports (APN1, APN2, APN3) between the first and second networks, the first network being equipped with control members producing:
parameters related to communications set up with mobile terminals, each comprising at least one identifier of the communicating mobile terminal user and an identifier of the type of communication, or
parameters related to failed connections, each comprising at least one identifier of the type of failed connection, and an identifier of the user of the mobile terminal concerned, or
parameters related to occupancy of the resources of the different elements of the first network, in particular of each of the gateway ports between the first and second network,
wherein it comprises at least one command line (LG2) controlling a port (APN1) of the gateway piloted by a management device (OMC1) managing elements of the network, the commanded port (APN1) being dedicated to access offers of general public type,
the command device comprising:
a module (PRGSTK) to collect parameters,
a module (PRG_MAN) to process collected parameters, adjusting at least one saturation indicator,
a command module (PRG_COM) adjusting the transfer capacity of the port (APN1) dedicated to access offers of general public type, in relation to the saturation indicator, so as not to encumber the first network or so as to make full use of the available bandwidth of the first network.

9. A communication system according to claim 8, wherein the second network (WEB1) is the Internet network, those general public users setting up Internet communications being identifiable in the first network via special marking of the headers encapsulating data transferred by the users.

10. A communication system according to claim 8, wherein the gateway of GGSN type (Gateway GPRS Support Node), or consisting of an independent server located between the GGSN of the first network and the second network, activates a priority function on its port (APN1) dedicated to access offers of general public type, giving priority to communications of web browsing type over communications of download type.

11. A communication system according to claim 8, wherein the control members are integrated in communication nodes (BT1, BT2, CTR1, GTR2) of the first network, or are control probes integrated in the first network.
